(19) United States
(12) Patent Application Publication
(10) Pub. No.: US 2017/0286873 A1
(43) Pub. Date: Oct. 5, 2017

(54) ELECTRONIC TICKET MANAGEMENT

(71) Applicant: Orange, Paris (FR)

(72) Inventors: Jean-Luc Grimault, Mondeville (FR); Jean Lemauviel, Chantepie (FR); Franck Grupeli, Caen (FR)

(21) Appl. No.: 15/508,152

(22) PCT Filed: Sep. 1, 2015
(86) PCT No.: PCT/FR2015/052314

§ 371 Date: Mar. 2, 2017

(30) Foreign Application Priority Data
Sep. 2, 2014 (FR) 1458202

(51) Int. Cl. G06Q 10/02; G06Q 20/32

(52) U.S. Cl. CPC G06Q 10/02; G06Q 20/3278; G06Q 20/3229

(57) ABSTRACT

A method for providing an electronic ticket by a security element associated with a mobile terminal. The ticket is stored in the mobile terminal and designed to access a service via an access control device. The method includes the following acts by the security element: receiving the electronic ticket originating from the mobile terminal; temporarily storing the electronic ticket in the security element; providing the electronic ticket for the access control device; authenticating taking into account at least one item of data contained in the ticket and one item of data linked to the security element; and deleting the ticket from the memory of the security device.

### CROSS-REFERENCE TO RELATED APPLICATIONS

This Application is a Section 371 National Stage Application of International Application No. PCT/FR2015/052314, filed Sep. 1, 2015, the content of which is incorporated herein by reference in its entirety, and published as WO 2016/034810 on Mar. 10, 2016, not in English.

### TECHNICAL FIELD

The invention relates to the general field of making paperless the titles to property otherwise known as “electronic tickets” and more particularly to the field of application in which an electronic ticket is intended to be saved in a handheld device suitable for reproducing said ticket in order to allow the user thereof to access a good or more generally a service.

It has a preferred, but not limiting, application in the applications for which the handheld device reproduces the electronic ticket by using a near field communication technique.

### PRIOR ART

The “near field” communication techniques are becoming widespread; the most used of these technologies for cellular telephony is that known by the abbreviation NFC (in English “Near Field Communication”). It is recalled that the “NFC” communications, based mainly on the ISO (International Standard Organization) 14443 standard, use wireless technologies to allow an exchange of information between two peripherals spaced apart by a short distance, typically less than ten centimeters.

The feasibility of services for making electronic tickets paperless on handheld devices by means of contactless technology has already been demonstrated.

Particularly known are transport services in which the users of public transport use a dedicated application of their handheld device in order to purchase electronic tickets and to validate their ticket at the entrance of the bus or of the streetcar by bringing their handheld device close to an access control apparatus suitable for communicating with the handheld device, or more precisely with a security element of the handheld device, via near field communication NFC means in order to obtain the electronic ticket so as to check the validity thereof.

“Security element” means, in this case, an element for storing and handling data for guaranteeing a user of the handheld device a high level of security since the data recorded in the security element is not accessible to a non-authorized user. “User” means the user of the handheld device, who is also the client of the ticket provider. This security element can, for example, be formed by a SIM (from the English Subscriber Identity Module) card, used in cellular telephony in order to store the information specific to the subscriber of a mobile network and applications of the user, of the operator thereof or, in some cases, of third parties. This security element can also be a “Secure SD Card” removable medium or a security element integrated in the device (“Embedded Secure Element”) or else a secured area of the application processor by virtue of the use of a security technology integrated in the processor and the peripheral components thereof (for example, the technology “Trustzone”, a registered trademark of ARM).

In the case of a device supporting Android applications (it is recalled that an Android application is a mobile application specifically developed for the handheld devices using the Android application system by Google), secure applications can also be executed in the Android device itself (using the version 4.4 “KitKat”), by virtue of the “HCE” (“Host Card Emulation”) technology.

Hereafter, the terms “security element” and “SIM card” will be used interchangeably.

“Access control apparatus” means a physical apparatus suitable for reading the content of the electronic ticket and checking the validity thereof in association with one or more servers for verification (of the validity date of the ticket, etc.) and for authentication (of the security element associated with the user of the handheld device). Hereafter, the terms “access control apparatus” and “terminal” will be used interchangeably. “Validation of the ticket” will mean both of the operations, namely verification of the ticket and authentication of the security element.

It is also possible to mention, using another example, the “M-Stadium” experiment, in Caen, France, which showed the integration of the contactless technology all along the route of spectators in a stadium: acquiring and making paperless electronic tickets on handheld devices, electronic ticket control and reading of interactive labels in the stadium, etc. The users of such a system previously load a ticket by means of a mobile application of their handheld device which is provided with the contactless technology. The data loaded in this manner, relating to the ticket, are saved and managed in a security element associated with the handheld device, in this case the SIM card of the user, then controlled at the entry to the stadium by means of a control device.

Also known, using yet another example chosen from the banking world, are payment services for which some banks have deployed, with traders, contactless electronic payment devices which can be used both with a bank card and with an NFC handheld device provided with a security element like the SIM card.

In all these examples, an application specific to the service is developed and then installed in the security element, such that the latter can authenticate the user for access to the service (transit pass, access to the soccer stadium, etc.) and at the same time manage data specific to the services. Relatively complex techniques must be used in order to load applications into the security element via service platforms located in the infrastructure of the mobile operator and/or of the service providers, so-called OTA (meaning “Over The Air”) techniques which comply with the specifications published by the association “Global Platform”. Such platforms are costly. The user cannot install such an application in a

SIM card himself. Moreover, the increase in the number of the dedicated applications considerably loads the SIM card which is generally limited in memory resources.

The invention proposes a system for controlling access to a service by the user of a handheld device provided with a security element, by validating an electronic ticket, which does not have such disadvantages.

### SUMMARY

According to a first functional aspect of the invention, a method is provided for making available an electronic ticket via a security element associated with a handheld device, the ticket being stored in the handheld device and provided for accessing a service via an access control apparatus, the method being characterized in that it includes the following steps in the security element:
a step of receiving the electronic ticket from the handheld device;
a step of temporarily saving the electronic ticket in the security element;
a step of making the electronic ticket available for the access control apparatus;
a step of authentication taking into account at least one item of data contained in the ticket and one item of data linked to the security element;
a step of deleting the ticket from the memory of the security apparatus.

Advantageously according to the invention, the ticket is not utilized by the security element but only made available to the access control apparatus by an application of the security element, called a security application (applet in computer language). Thus, the invention differs from the current techniques which require the installation of an application specific to each service in the security element of the handheld device (SIM card in particular), for example an application for access to a show and another application for transport tickets.

It is advantageous to host a single security application for making available the ticket which will be used in the security element, regardless of the type of this ticket. Indeed, the storage of applications in the SIM card requires OTA complex infrastructures. Moreover, installing a security application specific to each service in the SIM card assumes that the card has a sufficient amount of memory, which is not always the case, and all the more so since the number of services increases, as a result increasing the memory and complexity needs.

Finally, a security application in the SIM card is often not sufficient to cover the needs of the service and it is necessary to associate therewith an application on the handheld, particularly a graphic interface suitable for the service. This assembly formed from the specific application on the handheld interacting with the specific security application on the SIM card forms a technical assembly that is complex to develop and test.

The security element of the handheld device (SIM card for example) is used as a means of strong authentication, namely to provide the proof that the handheld device brought close to the terminal includes the correct security element, i.e. that of the user of the handheld device with which the security element (the SIM card of the user) is associated. It is therefore important that this function of strong authentication remains dedicated to the SIM card.

To summarize, the invention prevents the necessity of loading a security application specific to each service into the security element (application which should specifically manage the tickets according to the service to be provided, i.e. an application for transport, an application for payment, a third application for shows, etc.). However, it retains the advantages of the secure element, i.e. the strong authentication of the SIM card which stores the electronic ticket, under the control of a security applet which merely makes the ticket available to the terminal and does not therefore execute any specific analysis or management of the data of the ticket.

According to a specific method of implementing the invention, a method such as described above further includes the following steps:
a step of receiving, from the handheld device, a command for deleting the saved ticket.

Advantageously according to the invention, the ticket is therefore only stored in the security element temporarily. It is typically removed from the SIM card when the user has benefited from the service (for example has passed through the door of the frame associated with the access control apparatus) and therefore no longer requires the ticket in the SIM. However, the ticket can be retained in the handheld (for example, if it is a transport ticket valid over several days). It is advantageous, according to the invention, to store the tickets in the cellular phone and to temporarily make them available in the secure memory of the SIM card, since the tickets can be voluminous (in the number of bytes) and occupy a large memory space in the SIM card.

“Deleting” means, in this case, the removal or replacement of the ticket, the removal consisting in freeing up the memory whereas the replacement consists in storing another ticket (also temporary) in place of the ticket to be deleted, typically the following ticket selected by the handheld device. This method of implementing the invention makes it possible, while benefiting from the identification and security capabilities linked naturally to the security element, to not overload it.

According to a second specific method for implementing the invention, which can be implemented as an alternative to or in combination with the previous method, a method such as described above is such that said ticket comprises at least a public key for the security element, and is characterized in that it includes the steps of:
receiving a random coming from the access control apparatus;
signing the random by means of the private key of the security element;
making the signed random available for the access control apparatus.

The security procedure implemented according to the invention is extremely simple: the ticket sent by the ticket provider comprises a public key for the SIM card of the user, whereas the security element (SIM card) conventionally comprises the corresponding private key. If the random is correctly signed by the SIM card, the access control apparatus will be able to decrypt it by means of the public key contained in the ticket, thus authenticating the SIM card and therefore the user of the handheld device.

According to a third specific method of implementing the invention, which can be implemented as an alternative to or in combination with the previous methods, a method such as described above is further characterized in that at least part of the ticket has been signed by means of a private key of the issuing entity.

Advantageously, this signature of the message, or of part of the message contained in the ticket by the secret key of the issuing entity allows an additional authentication relating to the identity of the service (and ticket) provider to be added: the access control apparatus having access, directly or indirectly, to the public key of the issuing entity which provides the tickets, will be able to verify the authenticity of this provider by decrypting the encrypted message.

According to another functional aspect of the invention, a method is provided for managing an electronic ticket in a handheld device with which a security element is associated, the ticket being provided for accessing a service via an access control apparatus, this method being characterized in that it includes the following steps at the handheld device:
a step of selecting an electronic ticket saved by the device;
a step of sending said ticket to the security module.

Advantageously, the electronic ticket is therefore stored and managed within the handheld device by a ticket management application that runs on the handheld device and communicates with the security element. The electronic ticket is stored in a memory of the handheld device outside the secure element and transferred only after it has been selected, for example by the user by means of a graphic interface offering them a choice of tickets.

In accordance with the invention, the electronic tickets and the associated application (ticket management application) are loaded into the handheld device by flexible and simple techniques known to a person skilled in the art (for example SMS (Short Message Service) or MMS (Multimedia Message Service) short messages, downloading from a server of the mobile network or of the

Internet network via the mobile network, etc.) without it being necessary to resort to the complex techniques used to load applications or data into a SIM card via OTA platforms. In such a context, the user of the invention can advantageously install the application on his handheld device (for example an Android or Apple application) himself. Such an application can be adapted to each type of service or even to each service (adapted graphics and menus) without there being complex interaction between this application and the security application for authenticating and making available the ticket which is located in the secure element. Such an application can be dedicated to a certain type of services or, on the contrary, a single application on the handheld can manage all of the tickets of all of the services, without loss of generalities for the invention. Thus, the user can load several management applications into his cellular phone which generally has a larger memory than the SIM card.

At the same time, the temporary storage of the ticket in the SIM card limits the number of communication sessions to be put together between the terminal and the SIM-HANDHELD assembly: indeed, if the terminal had to converse simultaneously with an application on the cellular phone and another application on the SIM card, the cellular phone would have to open two separate sessions, for example a Bluetooth session (with the handheld device) and an NFC session (with the SIM card) or two NFC sessions, etc. It is naturally more simple to open a single session with the SIM card at the moment when it has the ticket.

According to a specific implementation method, a management method such as described above is further characterized in that the communication between the security element and the access control apparatus is near field communication.

The near field communication offers many advantages in this context of paperless tickets: a security which is intrinsic to this method of communication, since the user of the handheld device must be only a few centimeters from the terminal in order to be able to validate his ticket; but also, the NFC allows the ticket to be used even when the battery of the handheld device is flat or when the handheld is switched off: indeed, the access control apparatus can power the SIM card via the NFC field thereof, thus reading the ticket and the signed random even in the absence of battery.

According to a second specific method of implementing the invention, which can be implemented as an alternative to or in combination with the previous method, a management method as described above further includes a step of sending a command for deleting said ticket to the security module.

Advantageously, as noted previously, this aspect of the invention reduces the space occupied by the tickets in the security element. The deletion can be a removal or a replacement of the ticket (with another ticket).

According to a third specific method of implementing the invention, which can be implemented as an alternative to or in combination with the previous methods, a management method as described above further includes a prior step of receiving an electronic ticket from an issuing entity, said ticket comprising at least a public key for the user of the handheld device corresponding to the private key which is located in the security element.

Advantageously, as previously noted, if the ticket sent by the ticket provider comprises a public key for the SIM card of the user, whereas the security element comprises the corresponding private key, the SIM card and therefore the user of the handheld device are easily authenticated.

According to a fourth specific method of implementing the invention, which can be implemented as an alternative to or in combination with the previous methods, a management method as described above is further characterized in that the selection step is automatic if the powering level of the cellular phone is located below a predetermined threshold, and occurs according to a pre-established rule.

Advantageously, it is thus possible to process the ticket even when the cellular phone is almost without power: once the ticket has been transferred into the SIM card, the latter can be powered via the NFC near field and therefore no longer requires powering by the handheld device, which can even be switched off.

According to a variant of this embodiment of the invention, a management method according to the invention is further characterized in that the pre-established rule consists in selecting the last ticket looked at by the user.

Advantageously, the last ticket shown or accessed by the user is selected as being the most probable choice that the user would have made if he had carried out this selection himself, for example from a list of tickets.

According to a fifth specific method of implementing the invention, which can be implemented as an alternative to or in combination with the previous methods, a management method as described above is further characterized in that the selection step is automatic if the data contained in the ticket include certain predefined characteristics relating to the validity of the ticket.

Advantageously, the ticket closest to its expiry date can thus be “pushed” automatically towards the security module.

According to a hardware aspect, the invention also relates to a security element associated with a handheld device suitable for making available, to an access control apparatus, an electronic ticket stored in the handheld device, characterized in that it includes the following modules:
a receiving module arranged to receive an electronic ticket from the handheld device;
a module for temporarily saving the ticket;
a module for making the electronic ticket available for the access control apparatus;
an authentication module which can take into account at least one item of data contained in the ticket and one item of data linked to the security element;
a module for deleting the ticket from the memory of the security apparatus.

The term module can correspond both to a software component and to a hardware component or an assembly of hardware and software components, a software component itself corresponding to one or more computer programs or subprograms or more generally to any element of a program suitable for implementing a function or a set of functions as described for the modules in question. In the same manner, a hardware component corresponds to any element of a hardware assembly suitable for implementing a function or a set of functions for the module in question (integrated circuit, chip card, memory card, etc.).

According to another hardware aspect, the invention also relates to a handheld device with which is associated a security element, suitable for managing a ticket provided for accessing a service via an access control apparatus, characterized in that it includes the following modules:
a module for selecting an electronic ticket from the memory of the device;
a module for sending said ticket to the security module.

According to another hardware aspect, the invention also relates to a computer program suitable for being implemented by a method for making available electronic tickets as defined above, the program comprising code instructions which, when the program is executed by a processor, carries out the steps of the method for making available electronic tickets.

According to another hardware aspect, the invention also relates to a computer program suitable for being implemented by a method for managing electronic tickets as defined above, the program comprising code instructions which, when the program is executed by a processor, carries out the steps of the method for managing electronic tickets.

This security element, this device and these computer programs have features and advantages similar to those described previously with respect to the methods for making available and managing tickets.

According to another hardware aspect, the invention relates to a recording medium that can be read by a data processor on which a program is recorded, which program comprises program code instructions for executing the steps of the methods defined above.

The invention will be better understood upon reading the following description, given by way of example and with reference to the appended drawings.

THE FIGURES

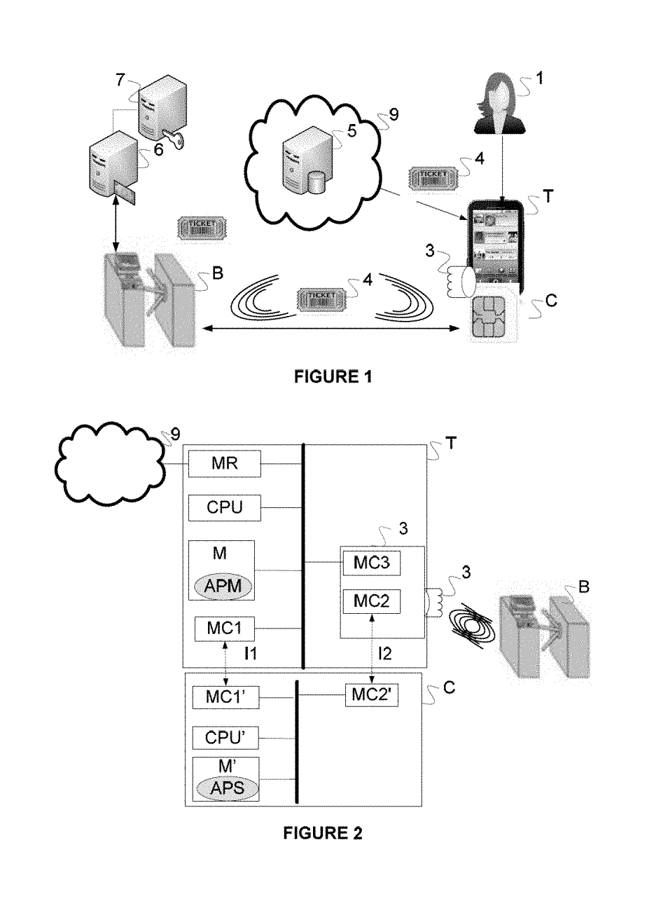

FIG. 1 shows the general context of an embodiment of the invention.

FIG. 2 shows an architecture of a piece of mobile equipment provided with a subscriber identity module and with an NFC module, which is suitable for implementing an embodiment of the invention.

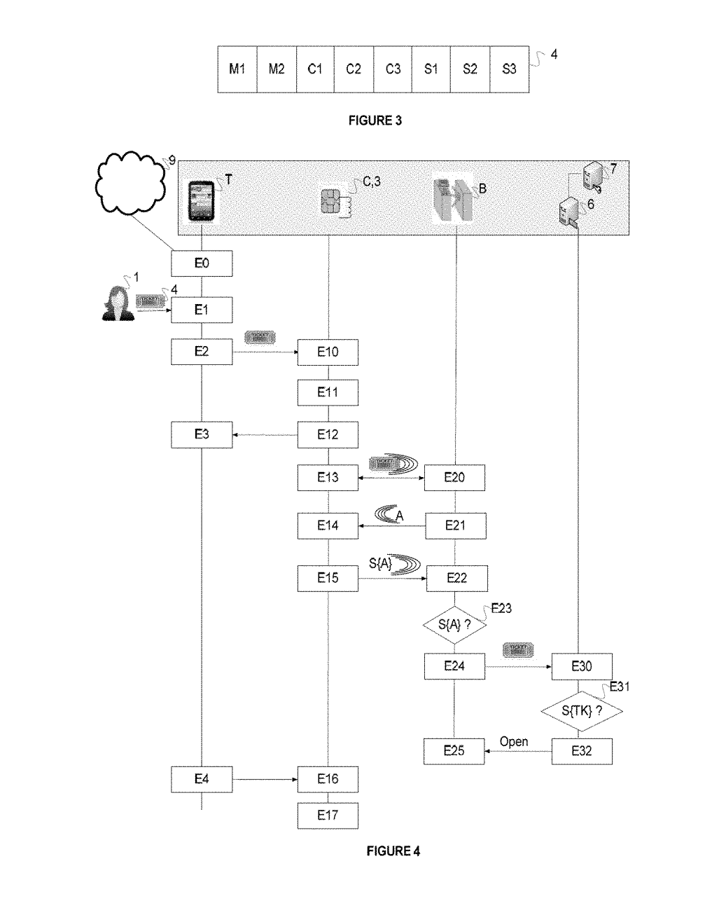

FIG. 3 shows the possible structure of an electronic ticket according to an embodiment of the invention.

FIG. 4 shows a flowchart illustrating the various steps of the method according to an embodiment of the invention.

### DETAILED DESCRIPTION OF AN EXEMPLARY EMBODIMENT ILLUSTRATING THE INVENTION

FIG. 1 corresponds to the general context of an embodiment of the invention; it relates to the local control, by an access control apparatus or terminal (B), of paperless tickets stored on the handheld (T) of a user (1), with an authentication by the security element (C). In this embodiment of the invention, the handheld device (T) also has an NFC module (3) allowing the use of contactless communications between the handheld, the associated SIM card (reference is also made in this case to NFC SIM) and the terminal (B).

It is recalled that the uses targeted by the invention are those for which the user must prove being in possession of a right of access to a service with a validity limited to a precise date or for a defined duration (for example, a transit pass for the month of October 2014) or with an electronic ticket number which can be verified when accessing the service (for example, access to a concert, a sports competition, etc.). It is considered, in this embodiment, that the intended application is an application for ticketing delivering concert tickets.

It is assumed in this case that the electronic tickets are provided by SMS to the user: the latter has chosen an electronic ticket (in this case, for a concert) from a service provider (5). The service provider (in this case, a concert ticket provider), located, in the example, in a network (9), has generated a ticket (4), signed it with the private key thereof, then transmitted it by SMS to the cellular phone of the user (T) (or several SMSs, due to the intrinsic limitation of the size of an SMS). The network (9) is, in this case, a mobile network but other types of networks would be possible, for example the Internet, an intranet network, etc. The user can order his ticket on the server of the service provider (5), with his handheld device, through a data connection of the mobile network extending to the Internet, and receive his ticket on his handheld as an SMS.

Before delivering the ticket, the service provider has verified that the user is registered with a trusted authority (not shown). It has obtained, from the trusted authority, the public key of the user, the name of the associated algorithm and the reference of the key. It is recalled that “public key” cryptography systems (also called “asymmetric cryptography”) are methods which are based on the use of a public key (which is broadcast) and of a private key (which is kept secret). In the context of the signature, the private key is used to sign a message and the public key is used to verify the validity of the signature of the message. An entity which has a certificate for the public key (certificate provided by a trusted authority) can thus authenticate the author of the message.

The public key for the user that the trusted authority provides to the ticket provider is the public key for which the corresponding private key is contained in the SIM card of the user. In the context of this embodiment of the invention, it is managed by an authentication and transit security application, that is called an application for making available tickets, or security application for short, that will be described later. For a subsequent purpose of authentication, the service provider can have integrated, in the ticket, information provided by the trusted authority and the user. A possible format for such a ticket will be described hereafter with reference to FIG. 3.

The handheld device (T) contains a mobile application (for example an Android application) for managing electronic tickets which particularly allows the user to display the relevant information linked to the data of the ticket (name of the show, date and time, etc.).

When the handheld device receives an SMS, the mobile application detects the ticket, for example upon the receipt of an SMS starting with a given identifier. This ticket is stored on the handheld. All of the tickets stored on the handheld appear in the interface that the mobile application for managing tickets proposes to the user, and can be used if their expiry date is not before the current date. Alternatively, the tickets can be managed by several applications on the handheld (one for transport, another for shows, etc.). The paperless electronic tickets are therefore not stored in the security element but on the handheld device. As will be seen hereafter, the security element is used solely for authenticating the user and for transiting the ticket (temporary storage before reading by the terminal (B)).

Each ticket can be selected by the user, for example by pressing a finger on the touchscreen of the cellular phone, and a dialog box can request therefrom a confirmation for the selection of the ticket.

The security element (C), or SIM card, contains a security application, also called an applet (APS) which is installed on the SIM cards of the users of handheld devices wishing to have access to the paperless ticket service. It is a single application for all tickets. Hereafter, it is called an applet, or security application, or else APS. It can access the private key of the user in the memory of the SIM card, which allows the SIM card, and therefore the user, to be authenticated with the access terminal. This applet also makes it possible to temporarily store the ticket which will be read by the terminal.

When the user selects the ticket (4) on his handheld device, the management mobile application APM sends the ticket to the applet of the SIM card and then requests the user to present his handheld device to the terminal.

When the user presents his handheld device to the access terminal, an NFC communication is established between the terminal and the NFC SIM card contained in the handheld device of the user. The terminal can then communicate with the SIM card in order to read the ticket previously saved. The applet of the SIM then makes it possible to authenticate the user, only the SIM card of which has the private key corresponding to the public key contained in the ticket.

The terminal (B) converses moreover with a “business” server (7) for verifying the tickets, which itself is linked to a server for verifying the signatures having the public key of the service provider (5) and verifies that the signature of the ticket (i.e. the signature by the service provider) is correct. These two servers are, according to this example, local servers. They can alternatively be located in the terminal itself or in a local network, or else in the wide area network.

After the stage of receiving the ticket by NFC, followed by the stage of sending the random to the SIM card and of receiving this signed random, the NFC terminal awaits the response from the ticket verification stages carried out by the business server (6) and the signature verification server (7). The NFC terminal can include a graphics interface, not shown, which allows it to display information intended for the carrier of the handheld device. For example, a “state” part indicates the state of the verification: the display of the terminal indicates, in green, that the access is authorized, in gray, what the user must do and, in red, any error that has occurred. If the stage for verifying the signature of the random by the SIM card, followed by the stage for verifying the “business” fields of the ticket, followed by the stage for verifying the signature of the service provider are correctly validated by the servers, then the terminal responds positively to the request of the user, for example it opens a gate to allow the latter to pass.

The terminal detects when the handheld device is no longer placed on the NFC reader, and can then start a new verification when a new device comes close to the NFC terminal.

With reference to FIG. 2, a system comprises a device T suitable for communicating with a network (9) including a ticket provider, and a security element (C) suitable for being inserted into the device (T) and for communicating with a terminal (B) in order to validate an electronic ticket.

The device T is, for example, a cellular phone or a PDA (meaning “Personal Digital Assistant”) or else a tablet.

The device T conventionally comprises a processing unit, or “CPU” (meaning “Central Processing Unit”), intended to load instructions into a memory, to execute them, and to carry out operations; a memory assembly M, including a volatile memory, or “RAM” (meaning “Random Access Memory”) used to execute code instructions, store variables, etc., and a nonvolatile “ROM” (from the English “Read Only Memory”) or “EEPROM” (meaning

“Electronically Erasable Programmable Read Only Memory”) memory for containing persistent data, used for example for storing the electronic tickets and the ticket management application APM.

The device T further includes:
a first communication module MC1 suitable for communicating with the security element C, via a first communication interface (I1).
a second communication module MR, allowing a communication, via a communication network, with remote servers, for example with the ticket provider (5) which is located in the Internet network (9) accessible via the mobile network or on a cellular telephone network. It is by this means that the handheld device (T) particularly receives the application APM (application in the handheld) for managing the tickets (according to the example herein, for a concert), which application is loaded in a memory M of the handheld, and then the tickets.
a third NFC contactless communication module (3), suitable for making the security element communicate with a remote piece of equipment via an NFC contactless link, for example the terminal B located close to the device T. The NFC contactless module is also suitable for conversing with the security element C, via a communication module MC2 and a second communication interface I2. It converses with the handheld device via an interface MC3. The NFC module conventionally includes an antenna suitable for sending and receiving messages having NFC radio modulation. The security element C is, for example, a UICC (meaning “Universal Integrated Circuit Card”) removable medium, also called a “SIM card”, a memory card hosting a secure element (SD card, Embedded Secure controller, etc.) or else a specific memory area of the device as in the context of the HCE standard defined above. The function of the security element C, commonly used for the mobile network authentication (the case of the SIM card), is, in addition to authenticating itself with the terminal, to store the information specific to the mobile subscriber (in this case called the user) and the processes which allow the equipment to be authenticated on the mobile network. To this end, it possesses the private key (K) of the user. It includes a first send-receive module MC1′ suitable for conversing with the device T via the first communication interface I1, a second send-receive module MC2′ suitable for communicating with the NFC module via the second communication interface I2.

In this embodiment of the invention, the security element C is a SIM card and conventionally includes ROM memories M′ particularly containing the system for utilizing the security element and programs implementing the security mechanisms, including the authentication algorithm for the card, EEPROM memories permanently containing directories and data defined by the mobile standard (for example GSM, UMTS, etc.), the authentication key (K), or private key (of the user), and specific applications (APS) also called applets which run in a RAM memory. The applets are, for example, software programs using the “SIM Application Toolkit” protocols according to the ETSI 102.223 recommendation, which make it possible to control some functions of the cellular phone, for example to converse with the subscriber via the communication interface I1 between the SIM and the cellular phone T. FIG. 2 shows the security applet APS common to all of the electronic ticket services. It implements the ticket transiting/temporary storage functions, makes the ticket available for the reading via NFC and signs a random received by NFC. In order to communicate with the SIM card, the application on the handheld uses the SmartCard API according to the ETSI 102.221 recommendation. It makes it possible to open a communication channel with the applets of the SIM card in order to send data (for example the ticket) as packets. Once the communication has ended, the Android application closes the channel to allow other Android applications or NFC readers to interact with the applet of the SIM card.

FIG. 3 shows the possible structure of an electronic ticket according to an embodiment of the invention.

The electronic ticket is structured so as to be able to provide all of the information, or data, allowing the authentication of the user. It also contains information on the expiry date, the seat number, the name of the event, the date, etc., for a ticket for access to a concert hall. Each service provider structures its ticket such that it can be read by the mobile application APM which receives the tickets. It is possible to use, for example, an “identifier/value” coding system: the useful items of data are then preceded by an identifier and are separated from one another by separation data. The ticket (4) shown in FIG. 3 comprises the following fields of data:
The subject of the ticket (M1) contains the name of the event, the number of the seat, the price, the date, etc.
The validity time period (M2) contains the expiry date of the ticket.
The dual-key reference (C1) contains the reference of the pair of keys of the user. The term “dual key” covers the assembly made up of the private key contained in the SIM card and of the public key corresponding to this private key. The private key is used by the SIM card in order to sign the random sent by the terminal (B); the corresponding public key is used by the terminal to verify this signature. Generally, all of the services use the same dual key, but sometimes services offered by large firms (for example transport companies) may have the intention of using a dual key that is specific thereto. This reference (C1) therefore informs the terminal of the dual key to be used. By virtue of this reference read in the ticket, the terminal (B) indicates to the SIM card which private key it must use in order to sign the random and which corresponding public key the terminal itself must use in order to verify the signature of the random.
The SIM authentication algorithm reference (C2) is the reference of the algorithm which is associated with the pair of keys of the user (C1). Indeed, some firms may desire not only that the dual key is specific thereto, but also that the authentication algorithm is specific thereto.
Advantageously, there is only a single private key in the SIM card and a single algorithm for all the services, which simplifies the SIM card, while preventing any service specificity in the card.
The public key of the SIM card (C3) is the public key of the user according to the dual key reference (C1).
The “ticket seller” identifier (S1) is the reference of the service provider who has sold and signed the ticket.
The signature algorithm reference (S2) is the reference of the algorithm which is associated with the pair of keys of the seller.
The signature (S3) is the signature obtained by signing the fields M1, M2, C1, C2, C3, S1 and S2. This signature is carried out by the service provider (ticket seller) before sending the ticket to the handheld of the user.

FIG. 4 shows an operation sequence for the exchanges between the various entities of the invention.

It is assumed in this case that the prerequisites for obtaining the ticket, which have already been described using FIG. 1, have been met during a step E0: the concert ticket (4) has been loaded onto the handheld of the user who wishes to pass through the terminal of the concert hall. A sequence of steps, which are clear for the user, is then carried out between the handheld (T), the NFC SIM card (C) and the terminal (B), the latter being shown at the top of FIG. 4.

When the user approaches, during a step E1, the terminal (B), with his handheld (T) hosting the ticket, he selects on his mobile application the ticket (4) to be used. The ticket management application APM on the handheld sends the ticket, during a step E2, to the applet APS of the SIM card and the ticket is temporarily stored at the step E11 in a memory (M′) of the SIM card. This is a temporary storage prior to reading by the terminal (B). As is well known to a person skilled in the art, in order to be sure that the ticket is sent to the correct applet, the latter can be identified by an identification number (called AID). It is recalled in this case that the secure applet has no knowledge of, nor manages, the content of the ticket: it only temporarily stores the ticket which will be used.

The applet of the SIM card verifies, during a step E12, that the ticket has indeed been received (loading the ticket can require several data packets), then optionally sends back a response confirming the receipt to the application APM for managing the ticket on the handheld, which receives it during a step E3 and can then request the user to present his phone to the access terminal.

When the user is located sufficiently close to the terminal, the latter reads the ticket (E20) in the memory of the SIM card under the control of the NFC module (E13): the terminal B immerses the handheld device in an electromagnetic field coming from the NFC module thereof. When the emitted electromagnetic field is high enough to correctly power the NFC module of the SIM card, i.e. when the cellular phone is sufficiently close to the terminal that the NFC module of the SIM card is powered, a communication can be established using the NFC protocol between the two apparatuses. In particular, as illustrated by the bidirectional arrow under the ticket, the terminal can read the ticket in the memory of the NFC SIM. Such an NFC communication is well known to a person skilled in the art and will not therefore be described in further detail. It will be noted however that, during the reading and subsequent authentication stages, the flow of the data of the NFC session passes through a controller (CLF meaning ContactLess Frontend) of the NFC module, which redirects the data to the NFC SIM card via the SWP (Single Wire Protocol) protocol. The invention makes it possible to open a single session with the SIM card, via the interface I2, and none with the handheld.

During a step E20, the terminal reads the key reference (C1) and the algorithm reference (C2) to be used at the SIM card for the signature of the random which will follow. Advantageously, there is only a single private key in the SIM card and a single signature algorithm for all of the services, which simplifies the SIM card, while preventing any specificity for the various services.

During an authentication step E21, the terminal sends to the NFC SIM a randomly generated number, also called a random. The fact of having a different random number on each occasion makes it possible to prevent a person who has succeeded in recovering a signature of an old random number from being able to reuse it.

The SIM card receives the random (A) during a step E14. During the step E15, the card signs it by using the private key thereof, and sends back the signed random S{A} to the terminal. In order to sign the random number, the applet uses cryptographic libraries of the SIM card which are well known to a person skilled in the art. It will be noted that only the SIM card of the user of the handheld device possesses this key, which means that the user is subjected to strong authentication by virtue of this signature.

The terminal receives the signature S{A} during the step E22 and then verifies (E23), using the public key of the user, that it read in the ticket, that the signature of this random number has indeed been produced with the private key of the user. If the step E23 fails, the process stops and the terminal does not give access to the service.

When the SIM card of the user is correctly authenticated, the terminal verifies, during the step E24, the validity date of the ticket: if it is incorrect, the process stops and the terminal does not give access to the service.

When the user is correctly authenticated (via his SIM card) and the date is valid, the terminal sends, during a step E24, the “business” fields of the ticket (M1, M2: name of the concert, date, seat number, etc.) to the business server (6). The business server verifies (E30) that the business fields are correct. If they are incorrect, the process stops and the terminal does not give access to the service.

The business server has the signature (S3) of the ticket verified (step E31) by the server (7) for verifying the signatures, since the server (7) has the public key of the service provider that has signed the ticket. If the signature of the ticket is valid, the business server sends to the terminal (E32) its agreement in order to authorize the user to access the service, i.e., in this case, enter the hall. The terminal opens the frame (E25) and the user can go in.

If the signature is not correct at the end of the step E31, the process stops and the terminal does not give access to the service.

Once the user has entered, the ticket can be unloaded from the memory of the SIM card (E16). According to a first example, the SIM card only contains one ticket at a time (in-transit ticket); a new ticket (of concert 2) replaces the ticket of concert 1 in the SIM: when the user selects ticket 2, it is transmitted to the SIM which deletes ticket 1, and the same applies for the following tickets. Therefore, this prevents the memory of the handheld from being needlessly overloaded. Alternatively, a command is sent by the management application on the handheld (APM) to the applet (APS) of the SIM card (E4).

It will be noted that, even when the battery of the handheld device is on the point of being drained, the invention can nevertheless deliver the service to the user. For example, according to a variant of the invention, when the battery reaches a critical threshold, the ticket with the earliest expiry date can be selected and therefore stored in the SIM card. Thus, even if the battery of the handheld is drained when the user presents the handheld to the terminal, the latter will be able to recover the ticket stored in the SIM card by powering it via the NFC electromagnetic field.

Other variants for automatically selecting the ticket when the battery threshold is reached can be envisaged: selection of the last ticket looked at by the user, selection depending on the data relating to the validity duration of the ticket, selection depending on the environment (giving priority to a subway ticket if the user is close to a station), etc. Moreover, it is possible to store no longer only one, but a few tickets in the SIM card.

Of course, the embodiment which has been described above has been given in a purely indicative manner that is in no way limiting, and many modifications can be easily implemented by a person skilled in the art without however departing from the scope of the invention.

1. A method for making available an electronic ticket via a security element associated with a handheld device, the ticket being stored in the handheld device and provided for accessing a service via an access control apparatus, the method comprising the following acts performed by the security element:
receiving the electronic ticket from the handheld device;
temporarily saving the electronic ticket in the security element;
making the electronic ticket available for the access control apparatus;
authenticating, taking into account at least one item of data contained in the ticket and one item of data linked to the security element; and
deleting the ticket from the memory of the security apparatus.

2. The method for making available an electronic ticket as claimed in claim 1, further comprising:
receiving by the security element, from the handheld device, a command for deleting the ticket saved in the security element.

3. The method for making available an electronic ticket as claimed in claim 1, said ticket comprising at least a public key for the security element, and wherein the method further comprises the following acts performed by the security element:
receiving a random from the access control apparatus;
signing the random by means of the private key of the security element;
making the signed random available for the access control apparatus.

4. The method for making available an electronic ticket as claimed in claim 1, wherein at least part of the ticket has been signed by a private key of the issuing entity.

5. A method for managing an electronic ticket in a handheld device, with which device a security element is associated, the ticket being provided for accessing a service via an access control apparatus, wherein the method comprises the following acts performed by the handheld device:
storing the electronic ticket in a non-transitory computer readable medium;
selecting the electronic ticket stored by the device in the medium;
sending said ticket to the security module.

6. The method for managing an electronic ticket as claimed in claim 5, wherein communication between the security element and the access control apparatus is near field communication.

7. The method for managing an electronic ticket in a handheld device as claimed in claim 5, further comprising sending a command for deleting said ticket from the handheld device to the security module.

8. The method for managing an electronic ticket in a handheld device as claimed in claim 5, further comprising a prior step of receiving the electronic ticket from an issuing entity, said ticket comprising at least a public key for a user of the handheld device corresponding to the private key which is located in the security element.

9. The method for managing an electronic ticket in a handheld device as claimed in claim 5, wherein the handheld device comprises a cellular phone and the selecting act is automatic if a powering level of the cellular phone is located below a predetermined threshold, and occurs according to a pre-established rule.

10. The method for managing an electronic ticket in a handheld device as claimed in claim 9, wherein the pre-established rule comprises selecting a last ticket looked at by the user.

11. The method for managing an electronic ticket in a handheld device as claimed in claim 5, wherein the selecting is automatic if data contained in the ticket includes certain predefined characteristics relating to validity of the ticket.

12. A security element associated with a handheld device suitable for making available, to an access control apparatus, an electronic ticket stored in the handheld device, wherein the security element comprises:
a non-transitory computer-readable medium comprising instructions stored thereon;
a processor configured by the instructions to perform acts comprising:
receiving an electronic ticket from the handheld device;
temporarily saving the ticket;
making the electronic ticket available for the access control apparatus;
authenticating, which takes into account at least one item of data contained in the ticket and one item of data linked to the security element; and
deleting the ticket from the memory of the security apparatus.

13. A handheld device with which is associated a security element, suitable for managing a ticket provided for accessing a service via an access control apparatus, wherein the handheld device comprises:
a non-transitory computer-readable medium comprising instructions stored thereon;
a processor configured by the instructions to perform acts comprising:
selecting an electronic ticket from a memory of the device; and
sending said ticket to the security module.

14. A computer program including code instructions for implementing a method for making available electronic tickets via a security element associated with a handheld device, when the instructions are executed by a processor of the security element, the ticket being stored in the handheld device and provided for accessing a service via an access control apparatus, wherein the instructions configure the processor to perform acts comprising:
receiving the electronic ticket from the handheld device;
temporarily saving the electronic ticket in the security element;
making the electronic ticket available for the access control apparatus;
authenticating, taking into account at least one item of data contained in the ticket and one item of data linked to the security element; and
deleting the ticket from the memory of the security apparatus.

15. A computer program including code instructions for implementing a method for managing tickets in a handheld device, when the implementation is executed by a processor of the handheld device, wherein the device is associated with a security element and the ticket is provided for accessing a service via an access control apparatus, and wherein the instructions configure the processor to perform the acts comprising:
storing the electronic ticket;
selecting the electronic ticket stored by the device; and
sending said ticket to the security module.
